(19) United States
(12) Patent Application Publication
(10) Pub. No.: US 2026/0075021 A1
(43) Pub. Date: Mar. 12, 2026

(54) SYSTEMS AND METHODS FOR AUTOMATED MESSAGING ELIGIBILITY-BASED FILTERING AND DELIVERY

(71) Applicant: YAHOO ASSETS LLC, New York, NY (US)

(72) Inventors: Sanika SHIRWADKAR, Milpitas, CA (US); Rofaida ABDELAAL, Sunnyvale, CA (US); Bhopal SINGH, San Jose, CA (US); Kenneth SEBASTIAN, Danville, CA (US)

(21) Appl. No.: 18/830,429

(22) Filed: Sep. 10, 2024

(51) Int. Cl. H04L 51/212

(52) U.S. Cl. CPC H04L 51/212

(57) ABSTRACT

Disclosed are systems and methods that provide a decision-intelligence (DI)-based, computerized framework for determining and implementing the mechanisms for processing messages pursuant to their eligibility for TLDR processing at the server and/or upon delivery to a recipient inbox. The disclosed framework provides novel mechanisms for triaging messaging, in that mechanism for how they are intra-, post- and/or in real-time processed by the server and/or recipient devices pursuant to providing actionable operations on such messages to ease their consumption by the recipient. The framework operates to determine which messages are eligible candidates for specific forms of triaging, then queues such messages for such types of triaging prior to and/or upon their delivery. Such intra-and/or post-delivery filtering and message management can effectuate an improved messaging experience as it relates to how messages are handled by inboxes and/or displayed for interaction by recipient users.

### FIELD OF THE DISCLOSURE

The present disclosure relates to electronic messaging, and more particularly, to a scalable, decision intelligence (DI)-based computerized framework for determining and implementing the mechanisms for processing messages for delivery pursuant to their eligibility for “too long; didn't read” (TLDR) processing at the server and/or upon delivery to a recipient inbox.

### SUMMARY OF THE DISCLOSURE

TLDR summarization, action prediction and title generation processing (TLDR, in general), in the context of electronic messaging (e.g. email) can improve the readability and comprehension of lengthy or complex email communications. TLDR processing involves computerized mechanisms that allow recipients to quickly grasp the main purpose of received messages, and decide how to proceed without having to read the entire message.

As discussed herein, TLDR mechanisms implemented by the disclosed systems and methods can operate to distill essential information from messages prior to their delivery, such that, for example, an email's main objective, any critical action items, and the most important conclusions or takeaways can be identified, compiled in a customized manner, and readily provided to the recipient upon display of the corresponding message (e.g., as a customized and/or modified message item).

According to some embodiments, the disclosed systems and methods provide a classification framework that enables automated TLDR filtering/selection and generation. As provided herein, email clients (e.g., at the server, and/or at the device-level via installed and/or cloud-based applications executing thereon) can utilize artificial intelligence and/or machine learning (AI/ML) tools that can, for example, analyze an email's structure, keywords, sentiment, and the like, to produce a concise, relevant deliverable message item for the recipient user's TLDR consumption. Accordingly, by incorporating TLDR processing into email communication and as par the processing of sent and to-be delivered messages (e.g., at the server), organizations and individuals can significantly improve the overall efficiency, clarity, and responsiveness of their email-based workflows and interactions.

According to some embodiments, as discussed herein, the disclosed framework operates to determine which messages are eligible for specific forms of triaging (e.g., summarization), then queues such messages for summarization according to the mechanism for which it will be delivered. In some embodiments, for example, a message can be analyzed by the messaging server (or on the recipient's device, or some combination thereof), for which actionable modifications can be added to the message upon its delivery within the inbox of the recipient. For example, messages can be summarized, action items added (e.g., forward, reply, add to calendar, search web, and the like), and the like, based on the eligibility determined from the analysis of the message prior to its delivery. In some embodiments, as discussed herein, candidates for such specific forms of messaging triaging can be based on, but not limited to, a message type (or class, used interchangeably), sender identifier (ID), recipient ID, content, content type, token count, category, age-appropriateness of the content (e.g., PG-13), a time, date, location of the recipient, and the like, or some combination thereof.

According to some embodiments, a method is disclosed for a DI-based computerized framework for determining and implementing the mechanisms for processing messages pursuant to their eligibility for TLDR processing at the server and/or upon delivery to a recipient inbox. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for determining and implementing the mechanisms for processing messages pursuant to their eligibility for TLDR processing at the server and/or upon delivery to a recipient inbox.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub- networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

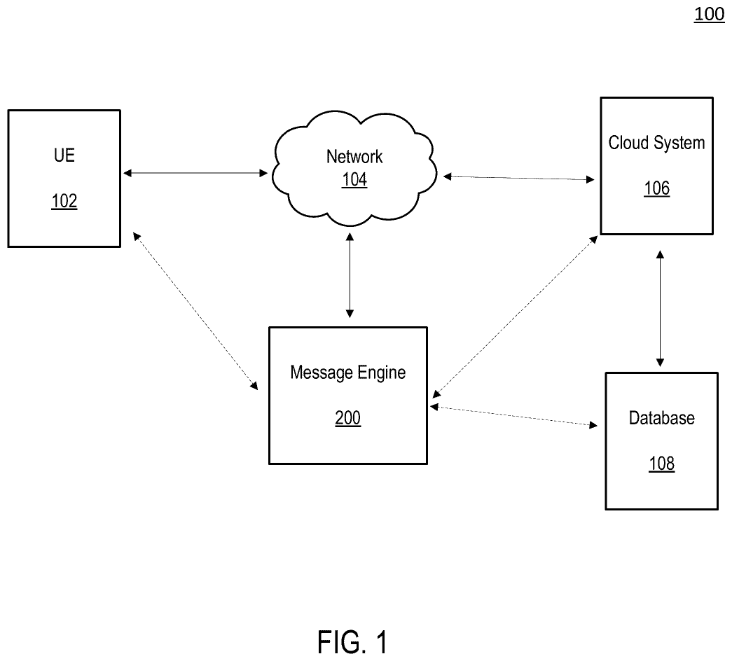

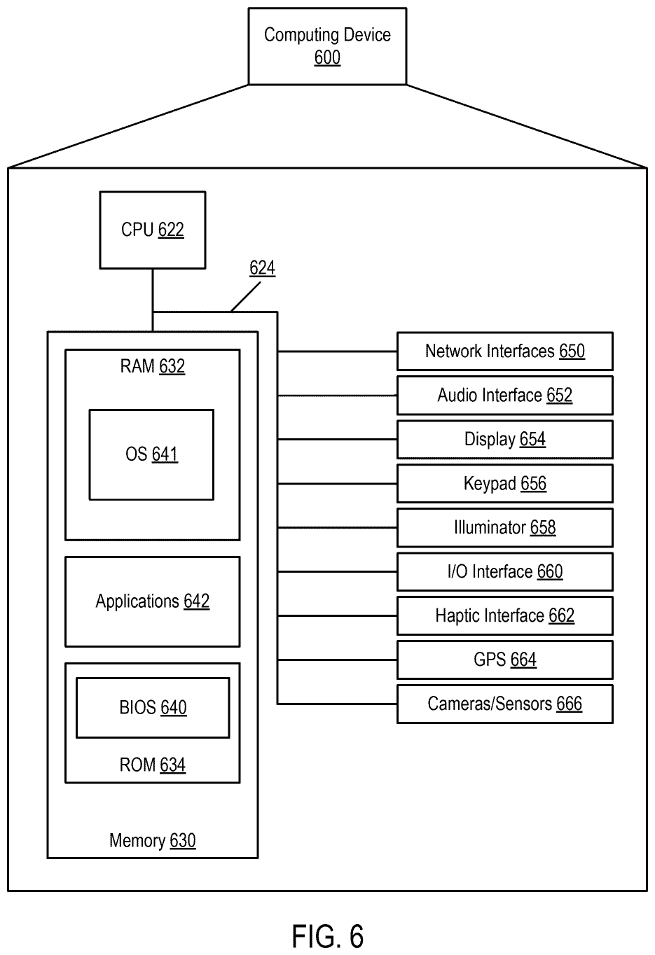

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108, and message engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with a cellular or wireless or wired transceiver.

In some embodiments, a peripheral device (not shown) can be connected to UE 102, and can be any type of peripheral device, such as, but not limited to, a wearable device (e.g., smart watch), printer, speaker, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a network and/or electronic mail platform (e.g., Yahoo! Mail®, for example), which has associated network resources hosted on the internet or private network (e.g., network 104), which enables (via engine 200) the tagging and search functionality and capabilities discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or message engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

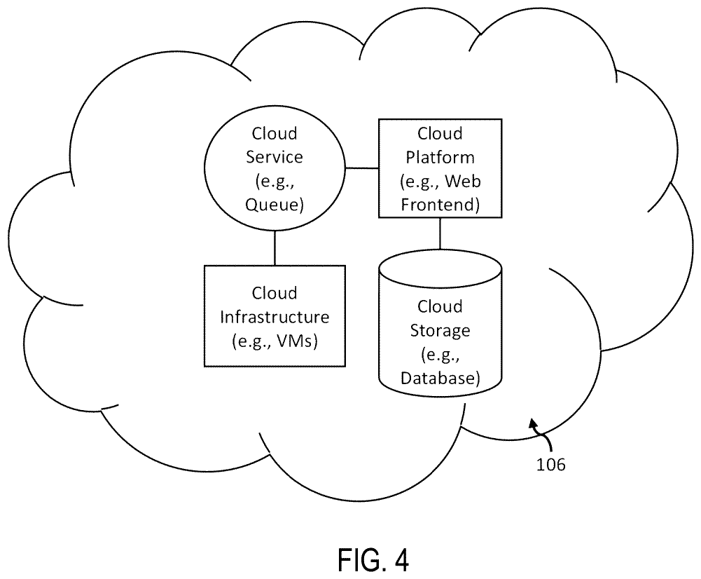

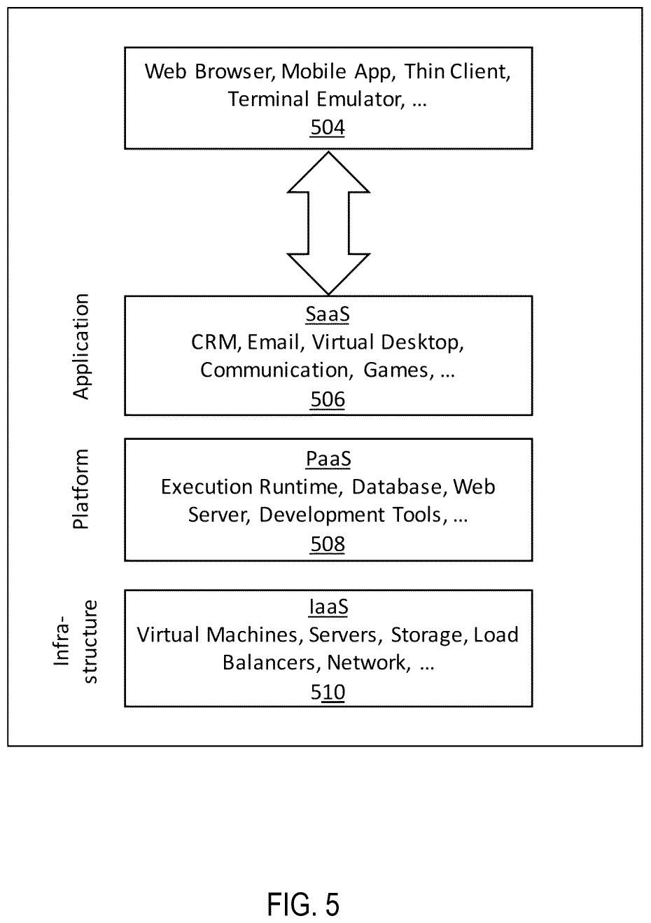

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Message engine 200, as discussed above and further below in more detail, can include components for the disclosed functionality. According to some embodiments, message engine 200 may be a special purpose machine or processor, and can be hosted by a device on network 104, within cloud system 106, and/or on UE 102. In some embodiments, engine 200 may be hosted by a server and/or set of servers associated with cloud system 106.

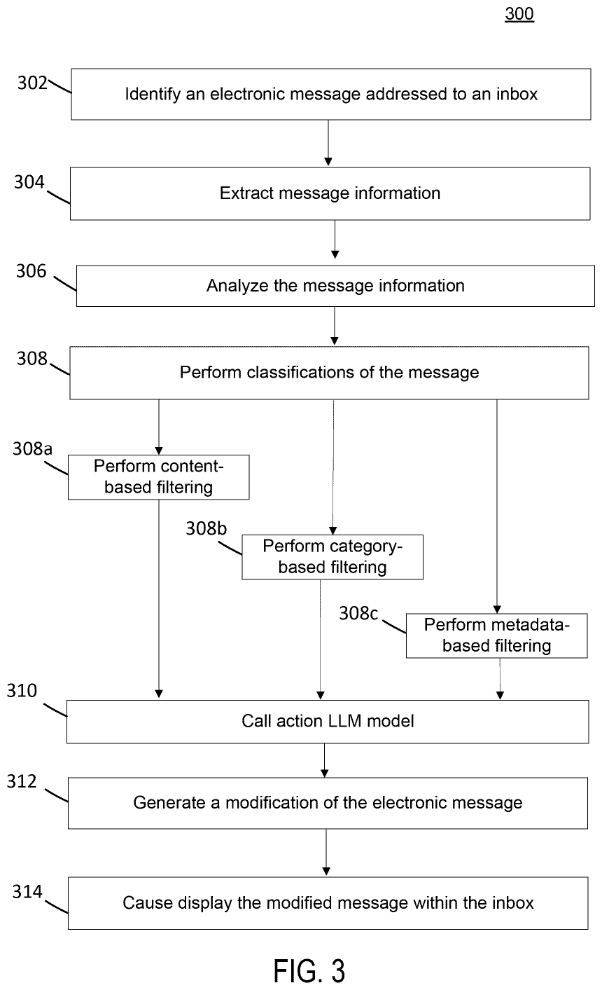

According to some embodiments, as discussed in more detail below, message engine 200 may be configured to implement and/or control a plurality of services and/or microservices, where each of the plurality of services/microservices are configured to execute a plurality of workflows associated with performing the disclosed search functionality. Non-limiting embodiments of such workflows are provided below in relation to at least FIG. 3.

According to some embodiments, as discussed above, message engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102.

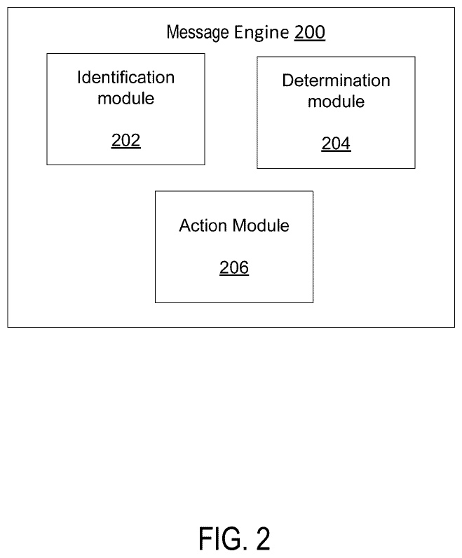

As illustrated in FIG. 2, according to some embodiments, message engine 200 includes identification module 202, determination module 204 and action module 206. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below. Message engine 200 or other device(s) running Process 300 may be operated entirely at the user device level, or with cloud support as a distributed system, or at a mail service provider's infrastructure, as non-limiting implementation examples. It will be understood that the disclosure herein provides for a configuration that is platform agnostic and may be operated on multiple alternative platforms as a matter of design choice using the teachings described.

Turning to FIG. 3, Process 300 provides non-limiting example embodiments for determining and implementing mechanisms for performing TLDR eligibility determinations, for which triaging operations are based therefrom. As provided below, the disclosed framework's configuration and implementation can provide a computerized suite of tools for providing advancements in how electronic messages are handled pursuant to their display within a recipient's inbox, as well as how users can interact with such electronic messages.

According to some embodiments, Steps 302, 304 and 310 of Process 300 can be performed by identification module 202 of message engine 200; Steps 306-308c can be performed by determination module 204; and Steps 312 and 314 can be performed by action module 206.

According to some embodiments, Process 300 begins with Step 302 where an electronic message addressed to an inbox of a user is identified. As discussed above, engine 200 can operate on a UE (e.g., sender and/or recipient device) and/or on a device on the network; therefore, in some embodiments, the identification of the message can be performed upon receiving the message at the relaying server (e.g., message server on network 104), and/or at the recipient device (e.g., via engine 200 acting in accordance with an email client running on a recipient user's UE).

Thus, as discussed herein, the disclosed operational steps of Process 300 can be performed at the cloud/network level, and/or at the user device level, without the need for cloud communication, as devices are now and in the future capable of running artificial intelligence (AI) applications in whole or in part without the need for cloud support.

In Step 304, engine 200 can operate to extract message information from the electronic message. In some embodiments, the message information can be based on and/or include, but not limited to, a message type, sender ID, recipient ID, content, content type, token count, category, character count, structure/format of the message (e.g., document object model (DOM) or template), age-appropriateness of the content (e.g., PG-13), a time, date, location of the recipient, and the like, or some combination thereof. For example, upon a server receiving the message from a sender UE, the server can cause engine 200 to execute Step 304.

In some embodiments, for example, the message can be routed through a mail transfer agent (MTA), where data and/or metadata related to the message can be processed, which can include, for example, the sender's address, recipient's address, subject, timestamp, header information, body information, and the like. During this phase, several filtering techniques, such as spam detection and virus scanning, can be applied to identify any malicious content. Headers within the email, which contain routing and protocol information, can be parsed for security checks and logging. Additionally, the MTA might utilize encryption or decryption methods to ensure the privacy of the message while in transit. This extraction and analysis process ensures that emails are secure, compliant with policies, and free from harmful content before being delivered to the recipient's inbox.

Accordingly, in some embodiments, Step 304 can involve engine 200 parsing the message, which can correspond to a type of criteria (which can correspond to any of the data/metadata types indicated above, for example) to extract certain types of information. In some embodiments, all extractable information can be identified/extracted in Step 304, and in some embodiments, a portion or subset of the information can be utilized.

According to some embodiments, the extracted message information can be stored in database 108, as discussed above.

In Step 306, engine 200 can analyze the extracted message information. According to some embodiments, the computational analysis performed in Step 306 can involve engine 200 calling and executing an AI, machine learning (ML) and/or large language model (LLM) that operates to classify (and/or filter)incoming electronic/digital communications, such as emails. In some embodiments, as discussed herein, when applied to classifying mail messages, the classification model(s) (and/or ensemble) can analyze the extract message information (from the electronic message, inclusive of the content and metadata associated therewith), to, inter alia, determine how to classify a message and perform filtering steps based on certain types of data, as discussed infra in relation to Steps 308-308c.

Accordingly, in some embodiments, the AI/ML models can be any type of known or to be known, specifically trained AI/ML model, particular machine learning model architecture, particular machine learning model type (e.g., convolutional neural network (CNN), recurrent neural network (RNN), autoencoder, support vector machine (SVM), and the like), or any other suitable definition of an AI/ML model or any suitable combination thereof.

In some embodiments, an LLM can be leveraged, as discussed herein, whether known or to be known. As discussed above, an LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, the message triaging model may be configured to identify and utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Accordingly, based on the AI/ML and/or LLM based analysis in Step 306, engine 200 can perform classifications of the message. Thus, in the runtime environment of message handling (e.g., at the server, as discussed herein), AI/ML and LLM models can be integrated to classify messages based on content, categories, types (and/or other forms of message information and/or data/metadata) in real-time, as discussed above. Thus, for example, when a message arrives at the server or MTA, for example, engine 200 can execute the AI/ML and/or LLM model(s) to process the message for purposes of classifying the message in relation to determining its eligibility for TLDR eligibility, as discussed herein. For example, engine 200, via the AI/ML and/or LLM, can tokenize and convert the content of the message into a format that the model can interpret. AI/ML models rely on pre-trained knowledge and patterns learned during training to identify key features in the text, such as the message's subject, intent, or sentiment. For example, the model might analyze the tone, keywords, and structure of the message to determine if it is spam, urgent, or business-related. In a runtime environment, the model's performance is continuously managed, ensuring that it classifies messages with minimal latency, even under high load. The runtime system also handles memory management, scaling, and exception handling, ensuring that the model operates smoothly without crashing or producing delays. By continuously analyzing and classifying messages as they come in, the runtime environment allows AI/ML and LLM models to provide real-time insights and automated categorization, which can be essential for applications like email filtering, customer support, or social media moderation.

Accordingly, as discussed herein, based on the classifications of the message (and/or message information) in Step 308, engine 200 can perform content-based filtering, as in Step 308a, category-based filtering, as in Step 308b, and/or metadata-based filtering, as in Step 308c. Accordingly, in some embodiments, the filtering in Steps 308a-308c can be performed via any of the AI/ML and/or LLMs discussed above.

Turning to Step 308a, engine 200's content-based filtering can be based on, but not limited to, a length of the email (e.g., character, word and/or token length), context of the message content, sentiment of the message content, emotions portrayed via the text and/or images (or other types of media) in the message, and the like.

For example, engine 200 can filter messages where the number of tokens exceeds a predetermined threshold. For example, if a message has less than or equal to 70 tokens, then it can be determined to be eligible for an actionable step, as per the below steps of Process 300 (e.g., summarization, for example).

In another example, for messages determined to be X-rated, personal and/or containing sensitive information, they are not deemed to be eligible, and can be sorted out (and/or sent to the spam or trash folder). In another example, messages of a content type relating to, but not limited to, educational, newsworthy, politics, learning, parental, priority, important, shopping, government, social, business, notifications, services, experiences, and the like, can be filtered (or identified) as eligible (or ineligible, which may be per user or another type of criteria). In some embodiments, such types of sub-content classes can be subject to combinational filtering (e.g., “AND” OR “OR-ing”, such that if a message is less than 70 tokens, but is X-rated, it will not be eligible, for example).

In some embodiments, in another example, if a message body is empty, and only an attachment is appended to the message, this can be excluded from filtering, and not subject to the triaging discussed herein.

In Step 308b, engine 200's category-based filtering can be based on, but not limited to, human messages, parenting topics, personalized events, call to action emails, notification emails, decorations (e.g., visual element or signature in the message), spam messages, messages from users with a threshold amount of activity (e.g., overall, per day, as a sender, and the like), conversation emails, non-text content, and the like, or some combination thereof.

For example, messages that are computer-generated, even while potentially important to the recipient (e.g., a receipt of a purchase), may be filtered to be excluded from eligibility for triaging. In another example, human messages may be included for filtering for triaging; however, if they are of a content type (e.g., from Step 308a), they may be excluded.

Therefore, while the “AND” and/or “OR-ing” may be per step, it can be cross-step or cross-filtering being performed (across Steps 308a, 308b and/or 308c, as discussed herein).

In Step 308c, engine 200's metadata-based (and/or data-based) filtering can be based on, sender, recipient(s), subject, date, time, size, attachments, attachment type, priority/importance, headers, domain, keywords, conversation status (e.g., is this a reply email or forward email), flags, location, and the like, or some combination thereof. Moreover, the metadata can correspond to, but not be limited to a format (e.g., HTML, plain text, rich text, for example) and/or structure of the message (e.g., DOM), and the like. Accordingly, in some embodiments, metadata-based filtering can be referred to as user-based filtering, where user signals can be aggregated (e.g., implicit and/or explicit user-based data, along with historical user-content engagement data, for example) can be utilized for such filtering.

Accordingly, in some embodiments, information related to the filtering determinations can be stored in database 108, as discussed above.

In Process 300, at the conclusion of Step 308's classification and the filtering steps of Step 308a-308c, engine 200 can determine, detect or otherwise identify whether the message is eligible for triaging, and which type of triaging. If not a candidate/eligible (e.g., excluded), engine 200 can cause the delivery of the electronic message in/to the inbox of the recipient. Such delivery can occur without modification of the message, and according to protocol of the messaging application/platform utilized to deliver such message (e.g., according to a delivery protocol defined by a message platform hosting the inbox).

In Step 310, when eligible, the message can be subject to analysis by an LLM model, for which, as in Steps 312-314, action steps can be performed. Thus, in Step 310, engine 200 can call an action/triaging model. In some embodiments, the triaging model can be a summarization model, quick actions model, and the like.

For example, a message summarization model can be an LLM which can perform operations to generate an NLP summary of the content associated with the electronic message. In some embodiments, the summary may be constricted to a number of characters proportional to an amount of space available within a message inbox item that is capable of being displayed within an inbox of a user's messaging account display page.

According to some embodiments, by way of a non-limiting example, engine 200 can call a message summarization model as disclosed in co-owned U.S. Ser. No. 18/738,869, filed on Jun. 10, 2024, titled “Systems And Methods For A Modified Message Display Including A Compiled Summary Within An Unopened Message Item.”

In another example, a quick actions model can be an LLM model that can analyze the message (and/or message information), and determine which quick actions to perform on the message and/or display in connection with the message. For example, add to calendar, view attachment, forward, reply, trash, and the like, all from the message item displayed in the inbox without having to open the message.

According to some embodiments, by way of a non-limiting example, engine 200 can call a quick action model as disclosed in co-owned U.S. Ser. No. 18/738,740, filed on Jun. 13, 2024, titled “Systems And Methods For Modifying Inbox Items With Quick Actions.”

Thus, as provided below in Steps 312 and 314, such model can execute to perform steps for generation of a summary, a curated/customized title of the email and/or provide actions for the user to perform on a message (e.g., add to calendar, respond, delete, forward, and the like), as discussed below.

In Step 312, engine 200 can execute the action model(s), which can perform a specifically curated TLDR triaging operation on the message, as discussed above. In some embodiments, this can cause the creation of a new message item and/or modified version of the electronic message's item. For example, if the message is an invitation to a party on Jan. 1, 2025 for the recipient's nephew's birthday, the summary can state “Birthday party on Jan. 1, 2025 for baby Lucas; please RSVP.” And, such message item can display an interface object (IO—button, for example) for the user to respond as to whether they will attend.

In some embodiments, upon execution of the action model(s), engine 200 can call and execute an AI/ML and/or LLM model. In some embodiments, such AI/ML and/or LLM model can be a separate model that can determine whether a context of the summary and/or accuracy of the quick actions correspond to or are similar (at least to a threshold) to a context of the content of the electronic message. Such analysis can be performed via any of the AI/ML and/or LLM models discussed above. In some embodiments, such AI/ML and/or LLM model can be a model used for the classification/filtering, discussed supra.

And, in Step 314, engine 200 can cause the display of the message item (from Step 312). In some embodiments, the message item can be displayed as a new mail item in the inbox listing of the recipient user's inbox account. In some embodiments, the message item can be displayed as a mail item within another tab of the inbox interface (UI) and/or within a separate folder of the inbox; where, in some embodiments, the original message may be displayed.

Accordingly, the disclosed framework provides novel mechanisms for determining which messages are to be triaged, and based on this determination/classification, displaying messages in a modified manner that provides users with previously non-native functionality for viewing and/or interacting with content of received messages.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by an application, an electronic message addressed to an inbox of a recipient;
analyzing, by the application, information associated with the electronic message;
determining, by the application, a classification of the message corresponding to a classification in a set of classifications that are based on types of the information associated with the electronic message;
filtering, by the application, the electronic message based on the determined classifications for each of the set of types of information;
determining, by the application, an action to perform on the message prior to delivery; and
causing, by the application, delivery of the electronic message based on the determination of the action.

2. The method of claim 1, further comprising:
performing content-based filtering of the message based on content information included within the set of types of information; and
determining whether the electronic message is eligible for the action, such that the determination of the action is based on the eligibility determination.

3. The method of claim 1, further comprising:
performing category-based filtering of the message based on category information included within the set of types of information; and
determining whether the electronic message is eligible for the action, such that the determination of the action is based on the eligibility determination.

4. The method of claim 1, further comprising:
performing metadata-based filtering of the message based on metadata included within the set of types of information; and
determining whether the electronic message is eligible for the action, such that the determination of the action is based on the eligibility determination.

5. The method of claim 1, further comprising:
performing user-based filtering of the message based on user engagement data within the set of types of information; and
determining whether the electronic message is eligible for the action, such that the determination of the action is based on the eligibility determination.

6. The method of claim 1, further comprising the information associated with the electronic message being selected from a group consisting of: a message type, sender ID, recipient ID, domain, content, content type, context, token count, category, a time, date, location, message structure and message format.

7. The method of claim 1, further comprising:
executing, by the application, a large language model (LLM) to perform the action, such that the caused delivery of the electronic message is based on output of the LLM.

8. The method of claim 1, further comprising:
compiling a summary of the electronic message, the summary compilation being the determined action; and
performing the delivery of the electronic message by causing the summary to be displayed within the inbox.

9. The method of claim 1, further comprising:
determining a set of quick actions related to a context of the electronic message, the quick action being the determined action; and
performing the delivery of the electronic message by causing the quick actions to be displayed within the inbox in association with a display of the electronic message.

10. A system comprising:
a processor configured to:
identify, by an application, an electronic message addressed to an inbox of a recipient;
analyze, by the application, information associated with the electronic message;
determine, by the application, a classification of the message corresponding to a classification in a set of classifications that are based on types of the information associated with the electronic message;
filter, by the application, the electronic message based on the determined classifications for each of the set of types of information;
determine, by the application, an action to perform on the message prior to delivery; and
cause, by the application, delivery of the electronic message based on the determination of the action.

11. The system of claim 10, wherein the processor is further configured to:
perform content-based filtering of the message based on content information included within the set of types of information; and
determine whether the electronic message is eligible for the action, such that the determination of the action is based on the eligibility determination.

12. The system of claim 10, wherein the processor is further configured to:
perform category-based filtering of the message based on category information included within the set of types of information; and
determine whether the electronic message is eligible for the action, such that the determination of the action is based on the eligibility determination.

13. The system of claim 10, wherein the processor is further configured to:
perform metadata-based filtering of the message based on metadata included within the set of types of information; and
determine whether the electronic message is eligible for the action, such that the determination of the action is based on the eligibility determination.

14. The system of claim 10, wherein the processor is further configured to:
perform user-based filtering of the message based on user engagement data within the set of types of information; and
determine whether the electronic message is eligible for the action, such that the determination of the action is based on the eligibility determination.

15. The system of claim 10, wherein the processor is further configured to:
compile a summary of the electronic message, the summary compilation being the determined action; and
perform the delivery of the electronic message by causing the summary to be displayed within the inbox.

16. The system of claim 10, wherein the processor is further configured to:
determine a set of quick actions related to a context of the electronic message, the quick action being the determined action; and
perform the delivery of the electronic message by causing the quick actions to be displayed within the inbox in association with a display of the electronic message.

17. A non-transitory computer-readable storage medium tangibly encoded with computer-executable instructions that when executed by a processor, perform a method comprising:
identifying, by an application, an electronic message addressed to an inbox of a recipient;
analyzing, by the application, information associated with the electronic message;
determining, by the application, a classification of the message corresponding to a classification in a set of classifications that are based on types of the information associated with the electronic message;
filtering, by the application, the electronic message based on the determined classifications for each of the set of types of information;
determining, by the application, an action to perform on the message prior to delivery; and
causing, by the application, delivery of the electronic message based on the determination of the action.

18. The non-transitory computer-readable storage medium of claim 17, further comprising:
performing content-based filtering of the message based on content information included within the set of types of information; and
determining whether the electronic message is eligible for the action, such that the determination of the action is based on the eligibility determination.

19. The non-transitory computer-readable storage medium of claim 17, further comprising:
performing category-based filtering of the message based on category information included within the set of types of information; and
determining whether the electronic message is eligible for the action, such that the determination of the action is based on the eligibility determination.

20. The non-transitory computer-readable storage medium of claim 17, further comprising:
performing metadata-based filtering of the message based on metadata included within the set of types of information, wherein the metadata is at least related to user engagement data; and
determining whether the electronic message is eligible for the action, such that the determination of the action is based on the eligibility determination.
